(19) United States
(12) Patent Application Publication
(10) Pub. No.: US 2025/0157441 A1
(43) Pub. Date: May 15, 2025

(54) SYSTEM AND APPARATUS FOR THE ELECTRONIC CONTROL OF RESONANCE INSTRUMENTS

(71) Applicant: ERIC GAGNON, BRAMPTON (CA)

(72) Inventor: ERIC GAGNON, BRAMPTON (CA)

(21) Appl. No.: 18/388,443

(22) Filed: Nov. 9, 2023

(51) Int. Cl. G10H 1/00; G10D 13/08; G10H 1/057; G10H 1/46

(52) U.S. Cl. CPC G10H 1/0008; G10D 13/08; G10H 1/0083; G10H 1/057; G10H 1/46; G10H 1/0066; G10H 2220/066; G10H 2220/201; G10H 2220/415; G10H 2240/285; G10H 2240/311; G10H 2240/321; G10H 2250/025

(57) ABSTRACT

An apparatus, system, and method that enables the control of a resonance instrument such as a singing bowl without the need of a mallet, but also without precluding the use of a mallet if it is desired. An electronic resonance vibrating apparatus includes an electronic control unit affixed to a base and a gesture sensor in electronic communication with the electronic control unit. The gesture sensor is configured to sense a position or change of position of a hand of a user. An exciter is also in electronic communication with the electronic control unit. The exciter is configured to be attached to a surface of an acoustic resonance instrument and vibrate the surface of the acoustic resonance instrument. Remote wireless or wired control of a multitude of such instruments configured in a network is also enabled via Wi-Fi, BLE and USB interfaces which also support the MIDI protocol as well as synchronized LED lighting effects.

### FIELD OF THE INVENTION

The present embodiments described in this specification relate generally to a system for the electronic control of resonance instruments, and specifically to a system and apparatus for the electronic control of resonance instruments using methods other than physical contact.

### BACKGROUND OF THE INVENTION

A singing bowl is a bowl-shaped object which can be made of different materials including crystals such as quartz or different types of metals such as alloys of copper and tin. Singing bowls are believed to have been around for 5000 years in a variety of cultures and used for religious, healing, and wellness purposes. Singing bowls may also be referred to as “sound bowls.” A mallet (or striker) is a stick used to play the singing bowl. The mallet may be felt-covered or have a rubber ball end. When a person plays the singing bowl in a healing context, the person is referred to as a sound healer or sound therapist. When a person plays the singing bowl in any context outside of the healing context, the person is referred to as a singing bowl performer.

Singing bowls have not fundamentally changed since their appearance estimated around 5000 years ago. However, in the 1970's, advances in semiconductor manufacturing equipment used to process silica sand enabled the manufacturing of the modern high-purity quartz crystal singing bowl and the introduction of the rubberized stick-slip type of mallets. Performers and sound healers have learned the art of playing the bowl using the mallet through a combination of fine motor skills involving the balance point of the stick, pressure against the bowl sidewall, modulating the dragging pressure and speed, pulling or pushing the mallet and using special percussion techniques. In this manner, a performer can produce a variety of calming sounds including dings, sustained tones, and amplitude modulated slow tremolo effects. Simultaneously playing two bowls close in frequency also results in a low frequency interference “beat” pattern that is pleasant to listen to.

There are many challenges to the traditional singing bowls, especially when used in a sound bath. A singing bowl will vibrate as long as the mallet is rubbed against it. Once this stops, depending on the purity of the bowl, it may keep resonating for up to about 10 seconds, but it will ultimately stop. A performer must constantly keep coming back to each bowl on a certain interval to keep it resonating. This limits the maximum number of bowls that can be played simultaneously. A skilled player can play two bowls simultaneously using both hands, each with one mallet which requires developed motor skills and coordination but is still inherently limited. By sequencing the play of additional bowls during the sustained resonance period, a few additional bowls can also be added to the chorus. However, the total number of bowls that may be played by a single user are practically limited to a maximum of two to five bowls.

One desirable feature that performers enjoy is having a “drone note” which keeps playing indefinitely in the background with a slow tremolo effect using a low pitch bowl and then layer their performance using higher pitch bowls playing on top of this background drone note. The drone note is difficult to keep going for extended periods of time. Because singing bowls require constant input by the performer, it is very difficult to maintain an automated drone note while freeing up the performer to focus on playing the higher notes.

The singing bowl placement is also limited by the reach of a performer's hands. A performer typically sits in the center of a room with one or two rows of bowls in a circular arrangement around him or her. The people attending the sound bath usually arrange themselves by lying down around this point in the room in a concentric fashion. The result is that the sound mostly comes from the same point in space with the exception of any acoustic reflections from the walls of the room. However, a performance would gain extra depth if bowls were able to be dispersed amongst the audience or everywhere around the room. This is not currently possible unless a performer runs between bowls to keep them going, which can be dangerous and impractical.

Some performers like to augment their performance by playing additional instruments to layer the soundscape. For example, performers may play the singing bowls and then get up and walk amongst the audience while playing other instruments, such as an ocean drum, a spirit drum, a native flute, a bansuri flute, chimes, harmonium, etc. However, performers have limited autonomy to do this because the singing bowl vibrations fade away several seconds after leaving the singing bowl. As such, performers usually must walk back to the singing bowls to get them manually vibrating again if they wish to maintain the performance of the singing bowl.

Some performers who do vocalizations and channeling while simultaneously playing the singing bowls report that it is difficult to concentrate on channeling while simultaneously concentrating on keeping the mallets moving in different directions and at different speeds while keeping consistent pressure with each hand. This requires a significant amount of focus and practice.

It is common for performers using crystal bowls to use small tea lights, whether real candles or electronic LED (Light-Emitting Diode) lights placed inside the singing bowl to generate a calming flame flicker or lighting effect. This illuminates the entire bowl, especially the white frosted type of crystal bowls. A common effect is that of a flickering flame or of a fixed color. Each bowl light is independent of the other and bowls don't typically synchronize together in the flickering or changing color effect.

Studio music producers often require a variety of different musical instruments to record new albums. Instead of owning all the physical instruments, they rely on a variety of virtual instruments whose sound is entirely synthesized by computer. These instruments are typically played from a standard musical keyboard interface using the Musical Instrument Digital Interface (MIDI) communication protocol. The music producer only needs to know how to play piano keys to generate sounds for a variety of instruments. Recording real-life instruments, however, adds an extra depth to the recording, including room acoustics/sound reflections of the real instrument body which is richer than a simple computer synthesized rendition of the same instrument. Physical singing bowls are currently not well suited for studio use by a producer using a MIDI keyboard since they require a trained singing bowl performer to play the instrument to be recorded by a microphone. This adds cost and complexity to the process.

A singing bowl has a primary fundamental resonant frequency as well as frequency overtones (higher frequency harmonics). There may be a single overtone or a multitude of overtones depending on how large the bowl is and how rich the sound is. When a mallet strikes the bowl or vibrates the bowl by constant friction, a fixed combination of the fundamental tone and the overtones are played at once. This combination of overtones gives a bowl its specific timbre or voice, which is not that of a pure sinusoidal tone but rather a mixture of sinusoids of different frequencies. It is difficult to only excite the bowl using a single frequency. However, exciting a singing bowl using a single frequency would yield a purer singing bowl tonality rather than a mixture of overtones.

While virtual, computer-synthesized renditions of singing bowls controlled by a MIDI protocol software are existent, computer-synthesized virtual singing bowls have an artificial sound in comparison to real singing bowls in a live setting. The loud vibrations and nuanced sonic interactions between singing bowls inside a room can only be replicated using real physical singing bowls. It is therefore desirable to control a real singing bowl rather than a mere recording of a singing bowl in the context of sound baths.

### SUMMARY OF THE INVENTION

The invention is a device that enables the control of a resonance instrument such as a singing bowl without the need of a mallet, but also without precluding the use of a mallet if it is desired. These new controls enable playing the instrument remotely either using a direct wired connection from a computer with MIDI control software or wirelessly via a smartphone device using similar control software. The ability to digitally control a singing bowl using a standard MIDI keyboard, whether wired or wireless, would enable the use of these electronic singing bowls in familiar studio environments by music producers. Moreover, the invention allows for a greater number of bowls to be simultaneously played while also being less tiring to the performer, who does not have to manually keep the singing bowls vibrating constantly.

Moreover, to also support local singing bowl interaction with a performer, a gesture sensor is included in the device to allow the performer to use his or her hand to directly control the instrument by hovering it above the bowl without making any direct contact. The hand movement at a height above the bowl may be used to electronically trigger resonant vibrations and modulate their amplitude in a more intuitive manner than by using a traditional mallet. Removing the need for a mallet also simplifies the interface between the performer and the instrument. Automatic controls also assist the performer in maintaining resonance of the bowl indefinitely without additional user input, saving a lot of effort. Additional gestures can be detected to control alternate functions. Wireless networking of a multitude of bowls enables synchronized LED lighting effects between bowls as well as the ability to remotely control them from a centralized location, enabling the dispersal of a large number of singing bowls throughout the audience without needing to circulate between them.

In one embodiment of the invention, an electronic resonance vibrating apparatus is provided. The electronic resonance vibrating apparatus includes an electronic control unit affixed to a base and a gesture sensor in electronic communication with the electronic control unit. The gesture sensor is configured to sense a position or change of position of a hand of a user. An exciter is also in electronic communication with the electronic control unit. The exciter is configured to be attached to a surface of an acoustic resonance instrument and vibrate the surface of the acoustic resonance instrument.

In another embodiment of the invention, the electronic resonance vibrating apparatus further includes a microphone in electronic communication with the electronic control unit. The microphone may be configured to sense emitted acoustic vibrations of the acoustic resonance instrument. A contact microphone such as a piezoelectric pickup may also alternatively be used to sense direct mechanical vibrations without be affected by room sounds. This has the advantage of allowing calibration of the bowl in noisy environments without having the extraneous sound adversely affecting the calibration process.

In a further embodiment of the invention, the electronic resonance vibrating apparatus also includes an amplifier in electronic communication with the electronic control unit and the exciter. The amplifier may be configured to receive a digital waveform sample from the electronic control unit and drive the exciter at a user-selected volume.

In yet a further embodiment of the invention, the base includes at least one contact pad disposed on a bottom face of the base and configured to support or affix the base on the acoustic resonance instrument.

In another embodiment, the electronic resonance vibrating apparatus also includes an LED array in electronic communication with the electronic control unit. In this instance, the electronic control unit may be configured to change the color of emitted light from the LED array based on emitted acoustic vibrations detected by the microphone or from commands received over a wired or wireless network.

In yet another embodiment, an electronic resonance vibrating system is provided. The electronic resonance vibrating system includes an acoustic resonance instrument, a base disposed on the acoustic resonance instrument, an electronic control unit affixed to the base, a gesture sensor in electronic communication with the electronic control unit, and an exciter attached to a surface of the acoustic resonance instrument. The gesture sensor may be configured to sense a position or change of position of a hand of a user. In addition, the exciter is in electronic communication with the electronic control unit and configured to vibrate the surface of the acoustic resonance instrument.

In yet a further embodiment, the acoustic resonance instrument may be a singing bowl. In this instance, the base is disposed on a bottom surface of the singing bowl while the exciter is affixed to a side surface of the singing bowl.

### BRIEF DESCRIPTION OF THE DRAWINGS

For a complete understanding of the nature and objects of the invention, reference should be made to the following detailed description taken in conjunction with the accompanying drawings in which:

FIG. 1 is a cutaway view of an electronic resonance vibrating system including a cutaway view of an electronic resonance vibrating apparatus as part of the electronic resonance vibrating system in accordance with an embodiment of the present invention;

FIG. 2 is a system diagram of an electronic resonance vibrating system in accordance with an embodiment of the present invention;

FIG. 3 is an electronic system diagram of an electronic resonance vibrating system in accordance with an embodiment of the present invention;

FIG. 4 is a system firmware architecture diagram of the electronic control unit in accordance with an embodiment of the present invention;

FIG. 5 is a flowchart of the automatic calibration algorithm used to automatically measure the fundamental resonant frequency and overtones of a resonance instrument in accordance with an embodiment of the present invention;

FIG. 6 is an illustration of zones in relation to the electronic resonance vibrating system when using gesture control in accordance with an embodiment of the present invention; and

FIG. 7 is a flowchart of the gesture sensing algorithm in accordance with an embodiment of the present invention.

### DETAILED DESCRIPTION OF EMBODIMENTS OF THE INVENTION

Preferred embodiments of the present invention will be described with reference to the accompanying drawings. It will be readily understood that the components of the present embodiments, as generally described and illustrated in the Figures herein, may be arranged and designed in a wide variety of different configurations. Thus, the following detailed description of the embodiments of the electronic resonance vibrating apparatus of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment described herein. Thus, appearances of the phrases “a select embodiment,” “in one embodiment,” or “in an embodiment” in various places throughout this specification are not necessarily referring to the same embodiment.

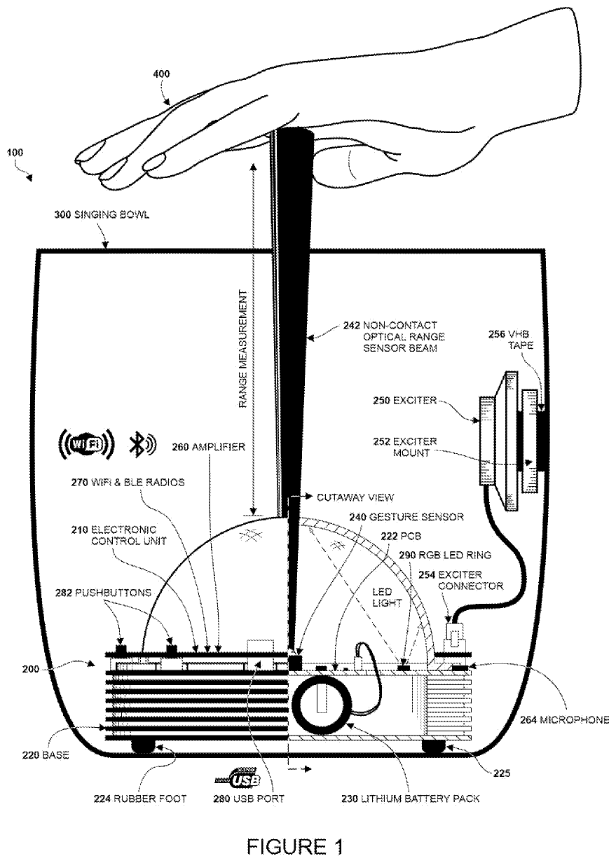

As depicted in FIG. 1, an electronic resonance vibrating system 100 includes an electronic resonance vibrating apparatus 200 and a resonance instrument 300. The resonance instrument illustrated in FIG. 1, by way of example, is a singing bowl. However, the resonance instrument 300 used in conjunction with the electronic resonance vibrating apparatus 200 may be any instrument that vibrates at a resonant frequency to make a sound. For example, the resonance instrument 300 may be a gong, a tuning fork, a euphonic array, or any other instrument that vibrates in its entirety to emit a sound. With the example of a singing bowl as an acoustic resonance instrument 300, the electronic resonance vibrating apparatus 200 is positioned preferably within the singing bowl, thereby enabling the electronic resonance vibrating system 100 to take the least amount of space.

The electronic resonance vibrating apparatus 200 includes an electronic control unit 210 affixed to a base 220. The electronic control unit 210 may be a processor or an integrated module microcontroller powered by a power source 230. In either case, the electronic control unit 210 may include non-volatile memory and volatile memory such as Random Access Memory (RAM) enabling the electronic control unit 210 to store and run any necessary firmware and software. Although the power source 230 may be a wired power source, such as a connection to a wall outlet, the power source 230 is preferably portable and contained within the base 220. For example, the power source 230 may be a lithium battery pack.

The base 220 may include one or more contact pads 224, 225 positioned on a bottom face of the base 220 to support or affix the base 220 on the acoustic resonance instrument 300. As depicted in FIG. 1, the contact pads 224, 225 support the base 220 on the bottom surface of the singing bowl, which is acting as the example acoustic resonance instrument 300. The contact pads 224, 225 may be rubber feet which allow for stably supporting the base 220 while minimizing any dampening effect of the base 220 within a vibrating acoustic resonance instrument 300. As the electronic resonance vibrating apparatus 200 is not limited to being used with a singing bowl and may be used in conjunction with any instrument that vibrates at a resonant frequency to make a sound, the electronic resonance vibrating apparatus 200 may be positioned on various acoustic resonance instruments 300. Accordingly, the contact pads 224, 225 may be configured in various ways to support the base 220 on a variety of acoustic resonance instruments 300.

A gesture sensor 240 is also in electronic communication with the electronic control unit 210. The gesture sensor 240 is configured to sense a position or change of position of a hand 400 of a user. To sense a relative position of a user's hand 400, the gesture sensor 240 may include an optical range sensor configured to emit an infrared optical range sensor beam 242 and detect a hand distance from the optical range sensor based on a detected infrared light deflected from the hand 400 of the user.

An exciter 250 may also be in electronic communication with the electronic control unit 210 via an exciter connector 254. The exciter 250 is an electronic audio transducer, like a speaker but without the sound cone, which produces mechanical vibrations against a surface to which it is affixed in response to an electrical signal from an audio amplifier. The exciter 250 is configured to be attached to a surface of an acoustic resonance instrument 300 and vibrate the surface of the acoustic resonance instrument 300. The exciter 250 vibrates using an electromagnetic exciter coil. As such, the vibrations are created by electromagnetic forces. In the case of a singing bowl as the acoustic resonance instrument 300, the exciter 250 may be affixed to an interior side surface of the singing bowl to enable the exciter to vibrate the main body of the singing bowl. The exciter may be affixed to the surface of the acoustic resonance instrument 300 using an exciter mount 252, to which the exciter 250 is mounted, and an adhesive 256 between the exciter mount 252 and the surface of the acoustic resonance instrument 300. The location of where the exciter 250 is placed on the acoustic resonance instrument 300 is ideally where dampening of the natural vibrations of the acoustic resonance instrument 300 is minimized. The adhesive 256 may be a double-sided tape or VHB (Very High Bonding) tape which adheres on one side to the exciter mount 252 and on the other side to the surface of the acoustic resonance instrument 300. Preferably, the adhesive 256 allows for bonding with the surface of the acoustic resonance instrument 300 without significant dampening of the vibrations emitted from the exciter 250 or damaging of the surface of the acoustic resonance instrument 300. The mount 252 allows for easy removal of the exciter 250 by simply unscrewing it, if necessary.

In another embodiment of the apparatus, the electronic resonance vibrating apparatus 200 further includes a microphone 264 in electronic communication with the electronic control unit 210. The microphone 264 is configured to sense emitted acoustic vibrations of the acoustic resonance instrument 300. The detected acoustic vibration frequency may be used as input data for the electronic control unit 210 during the calibration of the electronic resonance vibrating apparatus 200, as will be discussed in further detail below.

The electronic resonance vibrating apparatus 200 may further include an amplifier 260 in electronic communication with the electronic control unit 210 and the exciter 250. The amplifier 260 is configured to receive a digital waveform sample from the electronic control unit 210 and drive the exciter 250 in accordance with the received digital waveform sample and at a user-selected volume.

In a further embodiment, the electronic resonance vibrating apparatus 200 includes an LED array 290 in electronic communication with the electronic control unit 210. The electronic control unit 210 is configured to change the color of emitted light from the LED array 290 based on emitted acoustic vibrations detected by the microphone 264. LED lighting effects are provided to augment the audio-visual impact of the performance. Unlike using uncoordinated light sources, such as tea lights, the light effects from a connected LED array 290 may be configured to add complexity and be synchronized across bowls using a wireless Wi-Fi (Wireless Fidelity) network. Timing signals may be broadcasted from one electronic resonance vibrating system 100 to a network of other electronic resonance vibrating systems 100 to give a performance a unified look.

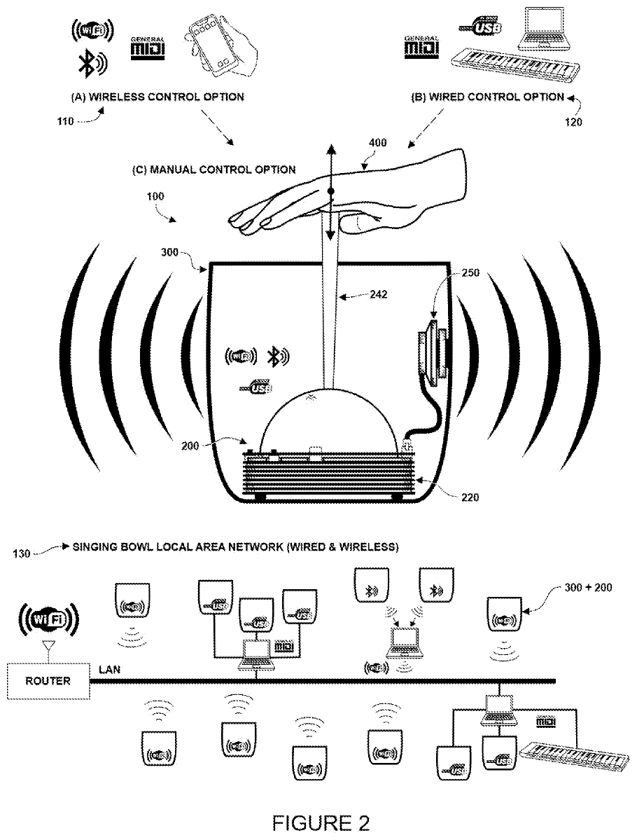

As depicted in FIG. 2, the electronic resonance vibrating system 100 may be a node on a network 130 in wireless communication with a wireless node 110 having wireless communication capabilities such as Wi-Fi or Bluetooth communication. To enable the electronic resonance vibrating system 100 to communicate with the wireless node 110, the electronic resonance vibrating apparatus 200 may include Wi-Fi and/or BLE (Bluetooth Low Energy) radios in communication with the electronic control unit 210. The Wi-Fi wireless interface further allows local networking of a multitude of electronic resonance vibrating systems 100 communicating together on the same network 130. In addition, the base 220 includes a USB port 280 in connection with the electronic control unit 210 enabling a wired connection via USB cord. Accordingly, the electronic resonance vibrating system 100 may be a node on the network 130 in wired communication with a node 120 via a USB (Universal Serial Bus) connection. Examples of wired nodes 120 include MIDI (Musical Instrument Digital Interface) controllers such as MIDI keyboards or laptop computers with music software interfaces.

Having the electronic resonance vibrating systems 100 on a local wireless network enables them to not only be remotely controlled from a central location, but also to display synchronized LED effects within all acoustic resonance instruments 300 in unison. As such, a user would have the ability of doing network synchronized sound and light effects across acoustic resonance instruments 300 in the network 130. In the context of a large and complex sound bath performance, special computer-based show control software could be used to play pre-recorded complex note sequences at specific times via a MIDI protocol, whether wired over a USB connection or wireless via WiFi or BLE connection. Having such an interface would allow the use of such software control.

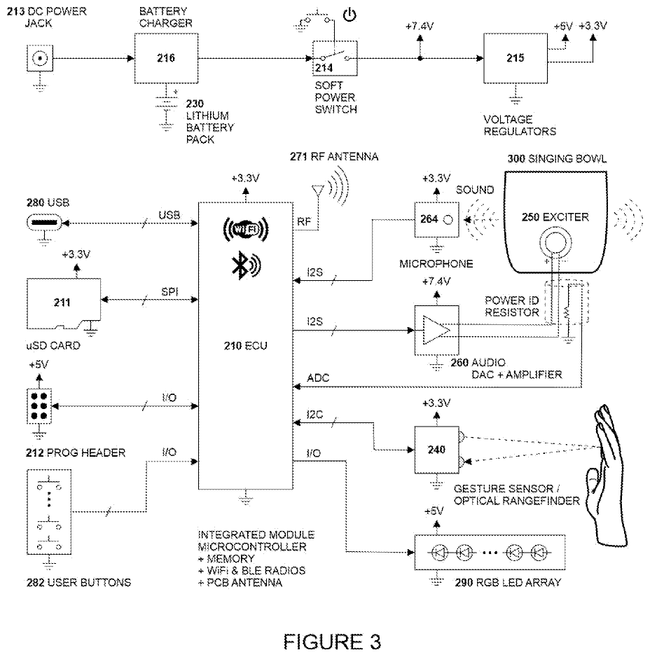

As shown in FIG. 3, the electronic control unit 210 is a central communication hub for multiple elements in the electronic resonance vibrating apparatus 200. For example, the electronic control unit 210 is in I/O (Input/Output) communication with a programming header 212, user buttons 282, and the LED array 290. The programming header 212 may be used for factory programming of initial system firmware for the electronic control unit 210. Once programmed, additional firmware updates may be performed by the user via the USB port 280 or the network 130 with one of the connected nodes 110, 120. The user buttons 282 may include push buttons configured to setup the electronic resonance vibrating apparatus 200 and select different operating modes. The user buttons may include functions such as increasing and decreasing volume level, adjusting the MIDI configuration, executing a calibration algorithm, adjusting a mode for the LED array 290, and selecting an overtone frequency for the exciter 250 to vibrate the acoustic resonance instrument 300.

The electronic control unit 210 may be in USB connection with the USB port 280 and/or be in SPI (Serial Peripheral Interface) connection with a SD (Secure Digital) card 211. The USB port 280 enables a USB connection for connecting to MIDI hardware or to provide system configuration and diagnostics file access. The SD card 211 may be a non-volatile memory card used to store audio clips, firmware update files, system logs, system configuration files and feature unlock keys.

The electronic control unit 210 may be in I²S (Inter-IC Sound) communication with the microphone 264 and the exciter 250 via the amplifier 260. The microphone 264 may be a digital MEMS (micro-electromechanical system) microphone configured to listen to ambient audio during calibration of the acoustic resonance instrument. The microphone 264 may also be configured to listen to ambient audio to provide input information for the electronic control unit 210 as the electronic control unit 210 controls sound-driven LED effects using the LED array 290. The electronic control unit 210 may also be in communication with an RF (Radio Frequency) antenna to support Wi-Fi and Bluetooth connectivity.

The amplifier 260 may include a digital-to-analog converter (DAC). In one embodiment, the amplifier 260 includes an integrated class D power amplifier. The amplifier 260 converts a digital audio stream (usually in I²S format) into an analog drive signal with suitable power to drive the electromagnetic exciter coil of the exciter 250. The exciter 250 generates mechanical vibrations in response to an electrical drive signal from the amplifier 260.

The electronic control unit 210 may be in I²C (Inter-Integrated Circuit) communication with the gesture sensor 240. The gesture sensor 240 may use an optical rangefinder configured to detect a range to a target (such as a user's hand 400).

As further depicted in FIG. 3, additional elements in the electronic resonance vibrating apparatus 200 may include a DC power jack 213, a battery charger 216, a soft power switch 214, and a voltage regulator 215 in either direct or indirect electrical communication with the electronic control unit 210. The DC power jack 213 is the connector to which an external AC (Alternating Current) to DC (Direct Current) adapter is connected to recharge the power source 230, such as an internal lithium battery pack. However, although the electronic control unit 210 may derive power from the internal power source 230 alone during normal operation, it is also possible to power the electronic control unit 210 from the power jack if desired, thereby powering the electronic control unit 210 from an external power source. The DC power source can also optionally be derived form the USB port.

The battery charger 216 includes a battery charger circuit configured to safely recharge the internal power source 230 from a connected external power source. The battery charger 216 is also configured to route the system power from either the DC power jack 213 or from the internal power source 230. In one embodiment, a depleted internal power source 230 will trigger the battery charger 216 to prioritize recharging the internal power source 230 over providing power to the electronic control unit 210. In an embodiment of the invention, the battery charger 216 includes one or more LEDs configured to indicate a state of charge of the internal power source 230.

The soft power switch 214 is configured to toggle the electronic resonance vibrating apparatus 200 power ON and OFF. The soft power switch 214 may also be configured to allow the electronic control unit 210 time to finish any work or save any open files to non-volatile memory before the electronic resonance vibrating apparatus 200 is shutdown. The voltage regulator 215 includes the DC/DC voltage regulators generating the various working voltages for the elements of the electronic resonance vibrating apparatus 200.

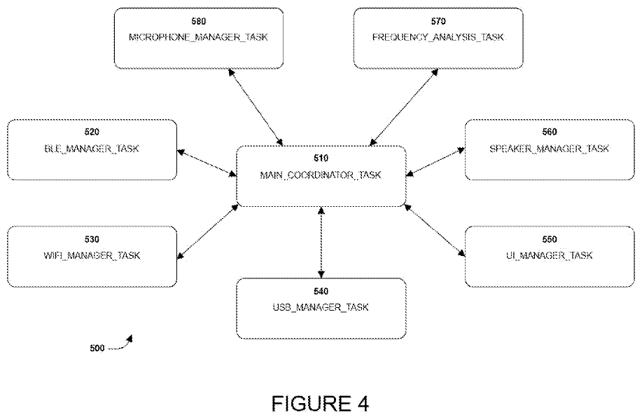

FIG. 4 depicts a system firmware architecture diagram 500 of the electronic control unit 210. The firmware operates over a real-time operating system (RTOS) and is configured to carry out various functions of the electronic control unit 210. Separate independent firmware tasks operate concurrently and are coordinated by a main coordinator task 510. The main coordinator task 510 initializes the software system run by the electronic control unit 210 and coordinates messages flowing between other tasks during run-time. The main coordinator task 510 contains the main system logic, diagnostic information, and a debug console. The BLE manager task 520 is responsible for BLE protocol as well as the MIDI over BLE logic. The BLE manager task 520 manages the connection between the electronic control unit 210 and a remote BLE host. The BLE manager task 520 is also responsible for receiving MIDI commands and forwarding them to the main coordinator task 510 as they are received.

The WIFI manager task 530 is responsible for the Wi-Fi protocol and the networking logic between nodes on the same network. The WIFI manager task 530 broadcasts and receives LED timing messages on the network 130. The WIFI manager task 530 is also configured to broadcast and receive gesture sensor information when a master acoustic resonance instrument 300 is used to control a remote slave acoustic resonance instrument 300 on the network 130. The WIFI manager task 530 is also responsible for the Wi-Fi access point (AP) mode to enable a user to connect directly using another electronic device, such as a smartphone or tablet, to configure the unit using an application or program on that device.

The USB manager task 540 is responsible for the USB protocol. The USB manager task 540 makes the device nominally appear as a MIDI over USB device to a host device. In a mode, the USB manager task 540 receives MIDI commands from a connected host and relays the messages to the main coordinator task 510. In a second mode, the electronic control unit 210 is powered ON with a pushbutton 282 held down, which makes the USB manager task 540 enumerate as a USB mass-storage device. This function enables the user to access stored files (e.g., configuration files, debug logs, feature unlock keys, etc.) using a standard desktop or laptop.

The UI manager task 550 is responsible for elements affecting user interfaces. These functions include reading the gesture sensor 240 and processing its output to generate desired actions, polling the user buttons 282, and handling the menu logic. In addition, the UI manager task 550 controls the LED array 290 and its light effects. The speaker manager task 560 is responsible for generating sinusoidal tones in real-time to be played by the exciter 250. The speaker manager task 560 is also responsible for playing pre-recorded human speech when requested. This speech signal is also played through the exciter 250 using the instrument itself acting as a low-fidelity loudspeaker.

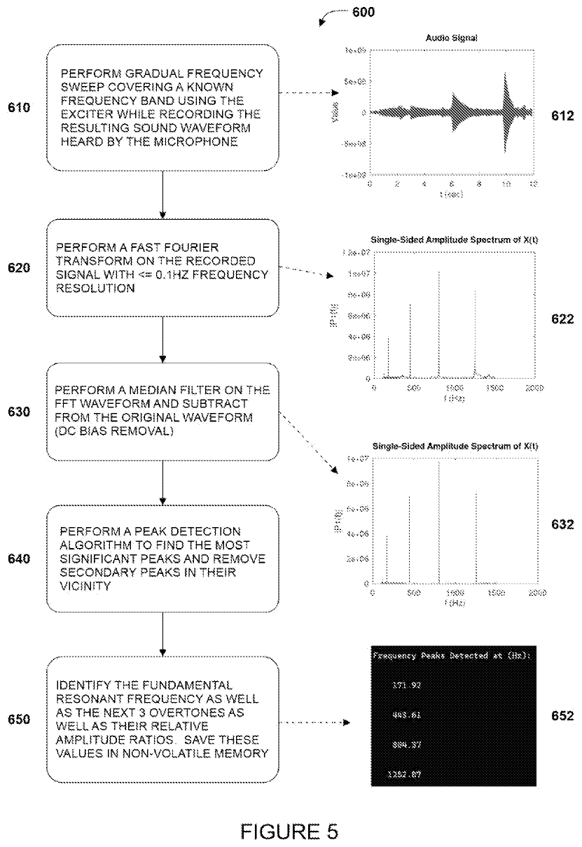

The frequency analysis task 570 is responsible for computing a fast Fourier transform and peak detection algorithm of a swept sine wave audio file recorded during the self-calibration process. The self-calibration process is explained in further detail with respect to FIG. 5 below. The microphone manager task 580 is responsible for capturing audio data from the microphone 264 and recording it to volatile memory when required.

Because each acoustic resonance instrument has a different resonance frequency, calibration of an electronic resonance vibrating apparatus must be made with respect to the acoustic resonance instrument it is to be paired with. As depicted in FIG. 5, an automatic calibration algorithm 600 begins with a first step 610, whereby a gradual frequency sweep is performed. Specifically, a sinusoidal signal is played using the exciter 250 starting from a lower limit frequency. Over a period of time, the frequency of the sinusoidal signal played through the exciter 250 is linearly increased until an upper limit frequency is reached. During this period of time, the microphone 264 records a microphone signal of the entire audio waveform and the recording is saved to memory. The audio signal chart 612 displays an example of a microphone signal recorded over a period of 12 seconds.

In a second step 620 of the automatic calibration algorithm 600, a fast Fourier transform of the entire recorded audio waveform is performed by the electronic control unit 210. To save memory space, results of the fast Fourier transform that are outside of the frequency range of interest may be discarded. The single-sided amplitude spectrum chart 622 displays an example amplitude spectrum that corresponds to the example recorded microphone signal in the audio signal chart 612.

The fast Fourier transform spectrum can have significant bias at lower frequencies. This bias typically consists of unwanted values since the resonant peaks are above the rest of the captured data. However, this bias can throw off the peak detection algorithm performed in the following step (the fourth step 640) when the peaks are not as strong in relation. Accordingly, in a third step 630, a median filter is performed, and a resulting waveform is subtracted from the original waveform. This step has the effect of removing slowly changing DC bias from the spectrum, thereby generating a cleaner signal for resonant peak detection in the fourth step 640. The single-sided amplitude spectrum chart 632 displays an example amplitude spectrum after a waveform resulting from a median filter has been subtracted from the original waveform displayed in the single-sided amplitude spectrum chart 622.

In the fourth step 640 of the automatic calibration algorithm 600, the removed bias from the previous step results in a fixed fraction of the resonant peak value, to which all the resonant peaks above a threshold are identified. Then, a peak merging step removes all neighboring peaks within a frequency band tolerance around the most significant resonant peaks. As such, only dominant resonant peaks remain by the end of the fourth step 640.

In the fifth step 650, a list of the first major resonant peak followed by the next three overtones is extracted. More overtones may optionally be extracted depending on the specific instrument (gongs can have at least 10 overtones). In addition, the respective amplitude ratios of the first major resonant peak followed by the next three overtones are saved in non-volatile memory. This recorded data allows scaling relative sinusoidal signals in the correct proportions when generating the sinusoidal signals to excite the bowl. The image 652 illustrates an example of a recorded first major resonant peak and the next three overtones that correspond to the peaks detected from the single-sided amplitude spectrum chart 632.

By generating a sinusoidal mechanical vibration through the exciter coil using the electronic control unit 210 and an amplifier 260 at the calibrated fundamental resonant frequency and/or overtones of the acoustic resonance instrument 300, such as a singing bowl, the singing bowl will resonate in a similar manner as when a mallet is rubbed against it. This enables purely electronic control of the singing bowl without the need of using a traditional mallet.

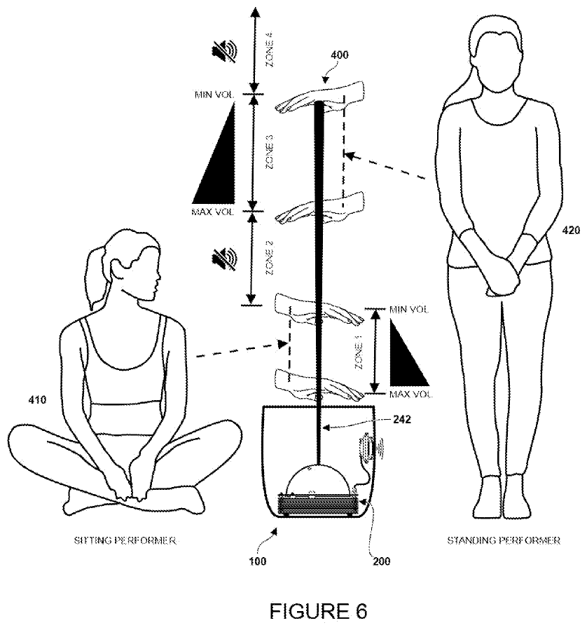

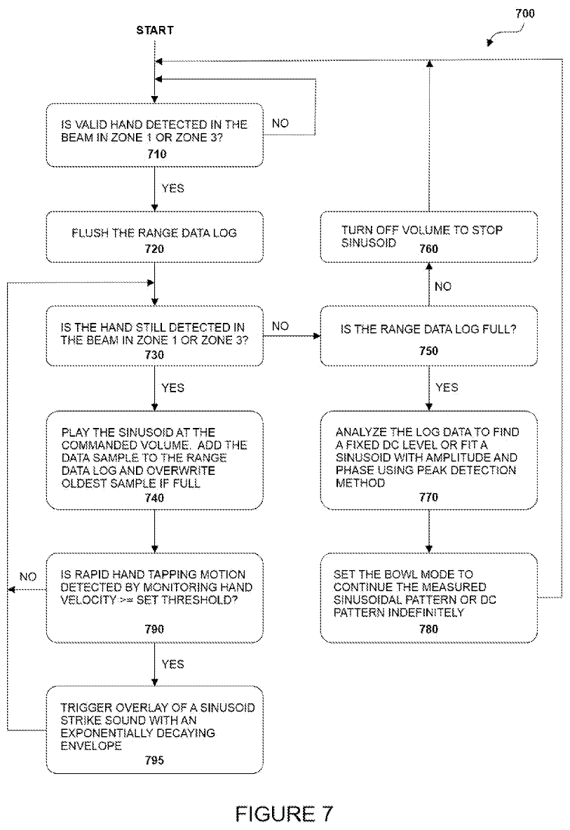

With respect to FIG. 6 and FIG. 7, the gesture control functionality of the electronic resonance vibrating apparatus 200 is described. The gesture sensor 240 and electronic control unit 210 perform an algorithm utilizing the optical rangefinder included in the gesture sensor 240. Distance information is retrieved by the gesture sensor by emitting an optical range sensor beam 242 and detecting a distance between the emission source at the gesture sensor 240 and a target object, such as a hand 400. Distance information retrieved from the gesture sensor 240 is used by the electronic control unit 210 to calculate a properly scaled sinusoidal signal to excite the acoustic resonance instrument 300, such as a singing bowl, at its resonant frequency.

To enable a user to control the electronic resonance vibrating system 100 or electronic resonance vibrating apparatus 200 from either a sitting position 410 or a standing position 420, the beam measurement range used by the gesture sensor 240 may be partitioned into four zones: Zones 1-4. As shown in FIG. 6, Zone 1 is the zone lowest to the ground and closest to the electronic resonance vibrating system 100. Within the range of Zone 1, the amplitude of the vibration emitted by the exciter 250 to the acoustic resonance instrument 300 varies from a maximum at a lowest point of Zone 1 to a minimum at a highest point of Zone 1. Within the range of Zone 2, the amplitude of the vibration emitted by the exciter 250 is set to zero and the sound emitted by the acoustic resonance instrument dies. Because of the position of Zones 1 and 2 in relation to the electronic resonance vibrating system 100, a user in the sitting position 410 can manipulate the electronic resonance vibrating system 100 within Zones 1 and 2.

Zones 3 and 4 are positioned to facilitate use by a user in a standing position 420. Within the range of Zone 3, the amplitude of the vibration emitted by the exciter 250 to the acoustic resonance instrument 300 varies from a maximum at a lowest point of Zone 3 to a minimum at a highest point of Zone 3. Within the range of Zone 4, the amplitude of the vibration emitted by the exciter 250 is set to zero and the sound emitted by the acoustic resonance instrument dies. In one embodiment of the invention, the exact values of the positional thresholds of each zone may be configured by the user based on their preferences.

The non-contact nature of the gesture sensor 240 enables a simple and intuitive manual method by which to locally control the acoustic resonance instrument 300 operation, which is useful in live performances.

A gesture sensing algorithm 700 performed by the electronic control unit 210 supports an “automatic continuation” feature. The electronic control unit 210 collects range data from the gesture sensor 240 over a period of time in a temporal buffer. The electronic control unit 210 analyzes the collected range data and identifies any range measurement pattern created by the user with their hand 400. Once a pattern is identified by the electronic control unit 210, the electronic resonance vibrating system 100 may automatically continue the identified pattern indefinitely should the hand 400 be removed from the optical range sensor beam 242. Moreover, the velocity of the hand 400 is monitored to detect a tapping gesture which triggers the synthesis of a mallet strike sound. The “automatic continuation” and tapping gesture detection features of the gesture sensing algorithm 700 are described in further detail with respect to FIG. 7.

FIG. 7 is a flowchart of the gesture sensing algorithm 700. First, it is determined whether a user's hand 400 is detected in Zone 1 or Zone 3 (710). Zone 1 and Zone 3 are the only two zones where the amplitude of the vibration emitted by the exciter 250 is above zero. A range data log is updated using a temporal buffer that runs collecting range data over a fixed time period, such as 5 seconds, at a gesture sensor sampling rate. If a user's hand 400 is detected in Zone 1 or Zone 3, the range data log is emptied (720).

Then, it is determined whether a user's hand 400 is still present in Zone 1 or Zone 3 (730). If so, then a vibration at the resonant frequency of the acoustic resonance instrument 300 is output by the exciter 250 with an amplitude based on the hand position within the respective zone. In addition, a data sample is logged into the range data log. If the range data log is full, the oldest data sample is overwritten to keep historical data from only the fixed time period (740).

In the event that the hand 400 was no longer detected in either Zone 1 or Zone 3, it is then determined whether the range data log is full (750). If the range data log is not full, not enough data has been collected in the range data log and a complete analysis for range measurement pattern identification will not be possible. As such, the exciter 250 is stopped (760). This is how the user may silence the bowl in practice. Specifically, the user may place their hand in the beam and remove it quickly before the range data log fills (e.g., less than 5 seconds).

If the range data log is full, an analysis is performed to attempt to fit a sinusoid within the log data, i.e., envelope amplitude, frequency and phase (770). This analysis is performed by conducting a peak detection analysis and measuring the average distance between peaks. Minimum and maximum values determine the amplitude of the vibration emitted by the exciter 250. The correct phase is extracted from the peak detection analysis to continue playing the same envelope modulation sinusoidal pattern in the same phase relationship identified. If the analysis is unsuccessful at identifying a sinusoidal pattern, then a fixed amplitude value of the signal envelope is used instead.

Upon successfully extracting and identifying properties of the user's hand gesture pattern or determining that the analysis was unsuccessful at identifying a sinusoidal pattern and merely emitting a vibration with the exciter 250 at a fixed amplitude, the identified sinusoidal pattern or constant amplitude vibration may be output indefinitely without additional effort or manipulation by the user (780).

The hand 400 velocity is monitored by looking at the rate of change of its position to detect a rapid tapping gesture. If the velocity exceeds a positive set threshold value (790), a mallet strike sound is synthesized in overlay as a sinusoidal step function with a rapidly decaying envelope (795).

What is claimed is:

1. An electronic resonance vibrating apparatus comprising:
an electronic control unit affixed to a base;
a gesture sensor in electronic communication with the electronic control unit, the gesture sensor being configured to sense a position or change of position of a hand of a user; and
an exciter in electronic communication with the electronic control unit, the exciter being configured to be attached to a surface of an acoustic resonance instrument and vibrate the surface of the acoustic resonance instrument; and
a wired interface and a wireless interface in electronic communication with the electronic control unit, each of the interfaces being configured to enable remote digital control of the electronic resonance vibrating apparatus and synchronization of the electronic resonance vibrating apparatus with one or more other electronic resonance vibrating apparatuses over a network.

2. The electronic resonance vibrating apparatus according to claim 1, further comprising a microphone in electronic communication with the electronic control unit, the microphone being configured to sense emitted acoustic or conducted vibrations of the acoustic resonance instrument.

3. The electronic resonance vibrating apparatus according to claim 1, further comprising an amplifier in electronic communication with the electronic control unit and the exciter, the amplifier being configured to receive a digital waveform sample from the electronic control unit and drive the exciter at a user-selected volume.

4. The electronic resonance vibrating apparatus according to claim 1, wherein the gesture sensor is an optical range sensor configured to emit a beam of infrared and detect a hand distance from the optical range sensor based on a detected infrared light deflected from the hand of the user.

5. The electronic resonance vibrating apparatus according to claim 1, wherein the base includes at least one contact pad disposed on a bottom face of the base and configured to support or affix the base on the acoustic resonance instrument.

6. The electronic resonance vibrating apparatus according to claim 2, further comprising an LED array in electronic communication with the electronic control unit, wherein the electronic control unit is configured to change the color of emitted light from the LED array based on emitted acoustic vibrations detected by the microphone or from commands received over a wired or wireless network.

7. The electronic resonance vibrating apparatus according to claim 4, wherein the hand distance detected by the gesture sensor is categorized into a first zone, a second zone, a third zone, and a fourth zone, organized in increasing distance from the optical range sensor.

8. The electronic resonance vibrating apparatus according to claim 7, wherein:
if the hand of the user is detected in the second zone or the fourth zone, an amplitude of the vibration emitted by the exciter is set to zero, and
if the hand of the user is detected in the first zone or the third zone, the amplitude of the vibration emitted by the exciter is determined based on a distance from the optical range sensor within the respective zone.

9. An electronic resonance vibrating system comprising:
an acoustic resonance instrument;
a base disposed on the acoustic resonance instrument;
an electronic control unit affixed to the base;
a gesture sensor in electronic communication with the electronic control unit, the gesture sensor being configured to sense a position or change of position of a hand of a user; and
an exciter attached to a surface of the acoustic resonance instrument, the excited being in electronic communication with the electronic control unit and configured to vibrate the surface of the acoustic resonance instrument.

10. The electronic resonance vibrating system according to claim 9, further comprising a microphone in electronic communication with the electronic control unit, the microphone being configured to sense emitted acoustic or conducted vibrations of the acoustic resonance instrument.

11. The electronic resonance vibrating system according to claim 9, further comprising an amplifier in electronic communication with the electronic control unit and the exciter, the amplifier being configured to receive a digital waveform sample from the electronic control unit and drive the exciter at a user-selected volume.

12. The electronic resonance vibrating system according to claim 9, wherein the gesture sensor is an optical range sensor configured to emit a beam of infrared and detect a hand distance from the optical range sensor based on a detected infrared light deflected from the hand of the user.

13. The electronic resonance vibrating system according to claim 9, further comprising at least one contact pad disposed between the base and the acoustic resonance instrument.

14. The electronic resonance vibrating system according to claim 10, further comprising an LED array in electronic communication with the electronic control unit, wherein the electronic control unit is configured to change the color of emitted light from the LED array based on emitted acoustic vibrations detected by the microphone or from commands received over a wired or wireless network.

15. The electronic resonance vibrating system according to claim 9, wherein the acoustic resonance instrument is a singing bowl, the base being disposed on a bottom surface of the singing bowl, and the exciter being affixed to a side surface of the singing bowl.

16. The electronic resonance vibrating apparatus according to claim 12, wherein the hand distance detected by the gesture sensor is categorized into a first zone, a second zone, a third zone, and a fourth zone, organized in increasing distance from the optical range sensor.

17. The electronic resonance vibrating apparatus according to claim 16, wherein:
if the hand of the user is detected in the second zone or the fourth zone, an amplitude of the vibration emitted by the exciter is set to zero, and
if the hand of the user is detected in the first zone or the third zone, the amplitude of the vibration emitted by the exciter is determined based on a distance from the optical range sensor within the respective zone, and
if a rapid hand tapping gesture is detected by monitoring a hand velocity, trigger a playback of an overlaid simulated instrument strike sound.

18. A method of controlling an electronic resonance vibrating system, the method comprising:
detecting a hand distance in relation to an acoustic resonance instrument;
determining whether the detected hand distance is in a first zone or a third zone of at least four zones;
if the hand distance is determined to be in either the first zone or the third zone, empty a range data log;
continue filling a range data log; and
if a hand of a user is still present in the first zone or the third zone, vibrate an exciter at a resonant frequency of the acoustic resonance instrument and with an amplitude based on the hand distance within the respective first or third zone; and
monitor a hand velocity to detect a tapping gesture and trigger an overlaid simulated instrument strike sound.

19. The method according to claim 18, further comprising:
determining whether the detected hand distance is in a second zone or a fourth zone of at least four zones; and
if the hand distance is determined to be in either the second zone or the fourth zone, setting the amplitude of the waveform emitted by the exciter to zero,
wherein:
a second zone of the at least four zones is between the first zone and the third zone and a fourth zone of the at least four zones is beyond the third zone, and
the second zone and the fourth zone.

20. The method according to claim 18, further comprising:
if the range data log is full, perform a peak detection analysis of data saved in the range data log;
measure an average distance between peaks detected in the peak detection analysis;
set a modulating envelope amplitude of the vibration emitted by the exciter based on minimum and maximum values;
determine whether a sinusoidal pattern is detected;
if a sinusoidal pattern is detected, play a sinusoidal modulating envelope pattern with a matching amplitude excursion and phase detected in the range data log; and
if a sinusoidal pattern is not detected, play a fixed amplitude sinusoid.
